(19) United States
(12) Patent Application Publication
(10) Pub. No.: US 2012/0242944 A1
(43) Pub. Date: Sep. 27, 2012

(54) LIQUID CRYSTAL DEVICE AND ELECTRONIC APPARATUS

(75) Inventor: Yutaka Tsuchiya, Hara-mura (JP)

(73) Assignee: Seiko Epson Corporation, Tokyo (JP)

(21) Appl. No.: 13/423,592

(22) Filed: Mar. 19, 2012

(30) Foreign Application Priority Data
Mar. 25, 2011 (JP) 2011-068216

(51) Int. Cl. G02F 1/1339

(52) U.S. Cl. 349/153

(57) ABSTRACT

A liquid crystal device includes a first substrate and a second substrate disposed so as to be opposite to each other, a liquid crystal layer interposed between the first substrate and the second substrate, a sealing material surrounding the liquid crystal layer and adhering the first substrate to the second substrate, a pixel region provided in a region surrounded by the sealing material, and a trap portion disposed between the pixel region and the sealing material. The trap portion includes a first electrode formed on the first substrate, a second electrode disposed to overlap the first electrode, and an insulating layer formed between the first electrode and the second electrode, and traps impurities in the liquid crystal layer by an electric field generated between the first electrode and the second electrode.

### BACKGROUND

1. Technical Field

The present invention relates to a liquid crystal device and an electronic apparatus.

2. Related Art

As liquid crystal devices including a trap portion which traps impurities in a liquid crystal layer by applying an electric field to the inside of the liquid crystal layer in order to prevent the impurities which are eluted from a sealing member from permeating into a pixel region, there have been used liquid crystal devices disclosed in JP-A-5-323336, JP-A-2000-221521, JP-A-8-201830, JP-A-10-123526, JP-A-2008-58497, and JP-A-2008-89938. In the liquid crystal devices disclosed in JP-A-5-323336, JP-A-2000-221521, and JP-A-8-201830, JP-A-10-123526, a pair of electrodes is formed on inner surface sides of a pair of substrates interposing a liquid crystal layer therebetween, and impurities in the liquid crystal layer are trapped by an electric field in the liquid crystal layer thickness direction (vertical electric field), generated between the pair of electrodes. In the liquid crystal devices disclosed in JP-A-2008-58497 and JP-A-2008-89938, a pair of electrodes is formed to be arranged on one substrate of a pair of substrates interposing the liquid crystal layer therebetween, and impurities in the liquid crystal layer are trapped by an electric field in the direction perpendicular to the liquid crystal layer thickness direction (horizontal electric field), generated between the pair of electrodes.

In order to efficiently trap the impurities in the liquid crystal layer, it is necessary to generate a large electric field between the electrodes. However, in the liquid crystal devices disclosed in JP-A-5-323336, JP-A-2000-221521, and JP-A-8-201830, JP-A-10-123526, since a pair of electrodes is disposed so as to be opposite to each other with the liquid crystal layer, which has the thickness of several μm, interposed therebetween, the distance between the electrodes increases, and thus it is difficult to generate a large electric field between the electrodes. In the liquid crystal devices disclosed in JP-A-2008-58497 and JP-A-2008-89938, the first electrode and the second electrode are patterned from the same conductive layer using a photo process, but the pattern is refined only with an accuracy of about 500 nm in performance of a typical photo process using i rays, and thus the distance between the electrodes may not be sufficiently short.

### SUMMARY

An advantage of some aspects of the invention is to provide a liquid crystal device and an electronic apparatus capable of efficiently trapping impurities in a liquid crystal layer by generating a large electric field between electrodes.

According to an aspect of the invention, there is provided a liquid crystal device including a first substrate; a second substrate disposed so as to be opposite to the first substrate; a liquid crystal layer interposed between the first substrate and the second substrate; a sealing material surrounding the liquid crystal layer and adhering the first substrate to the second substrate; a pixel region provided in a region surrounded by the sealing material and including a plurality of pixels; and a trap portion disposed between the pixel region and the sealing material, wherein the trap portion includes a first electrode formed on the first substrate, a second electrode disposed to overlap the first electrode such that a part of the first electrode is exposed when the first electrode is viewed from the liquid crystal layer in a plane state, and an insulating layer formed between the first electrode and the second electrode, and traps impurities in the liquid crystal layer by an electric field generated between the first electrode and the second electrode.

According to this configuration, the distance between the first electrode and the second electrode is controlled using the thickness of the insulating layer for insulating both the two electrodes from each other. In a typical semiconductor process, since the thickness of the insulating layer can be easily thinned up to 100 nm, the distance between the first electrode and the second electrode can be shortened as compared with a case where the first electrode and the second electrode are spaced apart from each other with the liquid crystal layer interposed therebetween or a case where the first electrode and the second electrode are formed to be arranged in the transverse direction. Therefore, it is possible to generate a large electric field between the first electrode and the second electrode, and to thereby efficiently trap impurities in the liquid crystal layer.

A driving type of the pixels may be a driving type other than an FFS (Fringe Field Switching) type.

In the FFS type, a pixel electrode and a common electrode are laminated on the same substrate via an insulating layer, and an alignment of the liquid crystal layer is controlled by an electric field generated between the pixel electrode and the common electrode. Since this structure is the same as the structure of the trap portion, impurities are easily trapped, and image sticking easily occurs. For this reason, a driving type of the pixels uses types other than the FFS type, and thereby it is possible to implement a liquid crystal device where the image sticking is difficult to generate.

The trap portion is disposed so as to surround the pixel region.

According to this configuration, it is possible to efficiently trap impurities permeating into the pixel region in various directions.

Here, the meaning of “the trap portion is disposed so as to surround the pixel region” is a concept including not only a configuration where the trap portion is formed in a closed frame shape along an outer circumference of the pixel region but also a configuration where the trap portion is formed so as to be divided into a plurality along an outer circumference of the pixel region.

In a case where the trap portion is formed in a closed frame shape along the outer circumference of the pixel region, it is possible to reliably trap impurities permeating into the pixel region. In a case where the trap portion is divided into a plurality, there is concern that impurities may permeate into the pixel region from the gaps between the divided trap portions, but, if the gaps are made to be narrow, it is possible to show high trapping performance (performance of trapping impurities) in the same manner as a case of not being divided. In a case where the trap portion is formed in a closed frame shape, there is concern that since the lengths of the first electrode and the second electrode increase, voltage drop is generated on the way and thus a deviation occurs in impurity trapping performance, but in a case where the trap portion is divided into a plurality, it is difficult for the problem to occur. Therefore, it is possible to show nearly uniform trapping performance at the overall trap portion.

The sealing material may include a first sealing region, and a second sealing region where, unlike the first sealing region, impurities are more easily eluted or more easily accumulate. In addition, the trap portion may include a first trap portion provided at a position opposite to the first sealing region; and a second trap portion provided at a position opposite to the second sealing region and having higher impurity trapping performance than the first trap portion.

Since the trapping performance of the trap portion is different for each region according to the ease with which impurities are eluted or accumulate, it is possible to better prevent impurities from permeating into the pixel region.

As methods for heightening the impurity trapping performance, there are the following methods.

The first method is a method where if a width of the first electrode in a direction perpendicular to the direction along the outer circumference of the pixel region is a width of the trap portion, a width of the second trap portion is larger than the width of the first trap portion. In this method, since the width of the second trap portion is larger, impurities are trapped in the second trap portion in a wide range, and thus the impurity trapping performance is heightened.

The second method is a method where if a length of the edge of the second electrode opposite to the first electrode is an interface distance, and an interface distance per unit length in the direction along the outer circumference of the pixel region is a unit interface distance, a unit interface distance in the second trap portion is larger than a unit interface distance in the first trap portion. In this method, since the unit interface distance in the second trap portion is larger, an electric field density of the second trap portion becomes great, and thus the impurity trapping performance is heightened.

As methods for increasing the unit interface distance, there are methods where, (1) a plurality of second electrodes are disposed so as to be opposite to the single first electrode, (2) the single second electrode is disposed so as to be opposite to the single first electrode in a meandering manner, (3) the second electrode is formed in a trapezoidal shape so as to have a frame portion with a rectangular frame shape and a plurality of step portions connected to the frame portion, (4) the second electrode is formed so as to have a stripe-shaped main line and a plurality of branches branched out from the main line, and (5) the second electrode is formed so as to have a plurality of ring portions and connection portions connecting the plurality of ring portions to each other.

The third method is a method where a thickness of the insulating layer of the second trap portion is smaller than a thickness of the insulating layer of the first trap portion. In this method, since the distance between the electrodes in the second trap portion is reduced, a large electric field is generated in the second trap portion, and thus the impurity trapping performance is heightened.

The fourth method is a method where a dielectric constant of the insulating layer of the second trap portion is greater than a dielectric constant of the insulating layer of the first trap portion. In this method, since the dielectric constant of the insulating layer of the second trap portion is larger, the electric field density of the second trap portion increases, and thus the impurity trapping performance is heightened.

The first substrate may be provided with a pixel electrode formed for each pixel and a wire connected to the pixel electrode, and the pixel electrode and the wire may be insulated from each other by the insulating layer.

According to this configuration, since the insulating layer for insulating the pixel electrode from the wire is commonly used as an insulating layer for insulating the first electrode from the second electrode, there is an advantage in that the configuration is simplified as compared with a case where the insulating layers are formed separately.

The first substrate may be provided with a pixel electrode formed for each pixel, the insulating layer covering the pixel electrode, and an alignment layer covering the insulating layer.

According to this configuration, since the passivation layer for protecting the pixel electrodes is commonly used as an insulating layer for insulating the first electrode from the second electrode, there is an advantage in that the configuration is simplified as compared with a case where the passivation layer and the insulating layer are formed separately. In addition, since the trap portion is disposed at a position close to the liquid crystal layer with the alignment layer interposed therebetween, an electric field generated by the trap portion easily acts on the liquid crystal layer. Further, the passivation layer for protecting the pixel electrode is formed as a thin film of about several hundreds of nm such that a large parasitic capacitance is not generated between the pixel electrodes and the liquid crystal layer. For this reason, if such a thin film is used as the insulating layer between the first electrode and the second electrode, the distance between the first electrode and the second electrode is shortened, and thus the impurity trapping performance is heightened.

According to another aspect of the invention, there is provided an electronic apparatus including the liquid crystal device according to the aspect of the invention.

According to this configuration, it is possible to efficiently trap impurities in the liquid crystal layer and to thereby provide an electronic apparatus where image sticking is difficult to generate and which thus has excellent display quality.

### BRIEF DESCRIPTION OF THE DRAWINGS

The invention will be described with reference to the accompanying drawings, wherein like numbers reference like elements.

FIGS. 1A and 1B are a plan view and a partial cross-sectional view of a liquid crystal device according to a first embodiment.

FIG. 2 is a partial cross-sectional view of a liquid crystal device according to a second embodiment.

FIG. 3 is a plan view of a liquid crystal device according to a third embodiment.

FIG. 4 is an enlarged plan view illustrating a configuration of a trap portion around the sealant provided in the liquid crystal device according to a fourth embodiment.

FIG. 5 is an enlarged plan view illustrating a configuration of a trap portion around the sealant provided in the liquid crystal device according to a fifth embodiment.

FIGS. 6A to 6F are plan views illustrating variations of the trap portion.

FIG. 7 is an enlarged plan view illustrating a configuration of the trap portion around the corner of the sealing material provided in a liquid crystal device according to a sixth embodiment.

FIG. 8 is an enlarged plan view illustrating a configuration of the trap portion around the corner of the sealing material provided in a liquid crystal device according to a seventh embodiment.

FIGS. 9A and 9B are enlarged plan views illustrating a configuration of the trap portion around the corner of the sealing material provided in a liquid crystal device according to an eighth embodiment.

FIGS. 10A and 10B are enlarged plan views illustrating a configuration of the trap portion around the corner of the sealing material provided in a liquid crystal device according to a ninth embodiment.

FIG. 11 is a schematic configuration diagram of a projector which is an example of the electronic apparatus.

### DESCRIPTION OF EXEMPLARY EMBODIMENTS

### First Embodiment

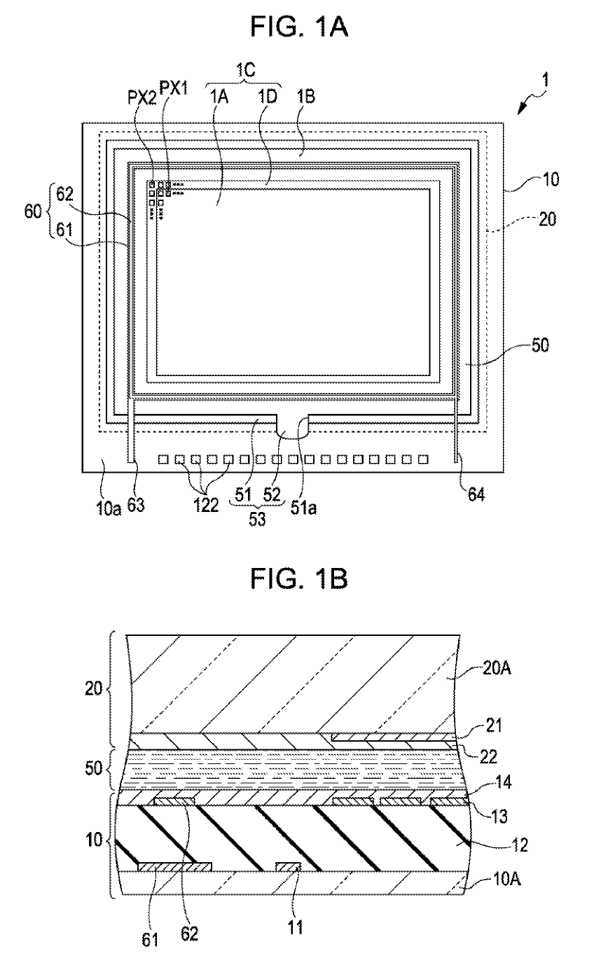

FIG. 1A is a plan view of a liquid crystal device 1 according to the first embodiment, and FIG. 1B is a cross-sectional view illustrating the vicinity of a trap portion provided in the liquid crystal device 1.

The liquid crystal device 1 includes a TFT array substrate (first substrate) 10, an opposite substrate (second substrate) 20 which is disposed so as to be opposite to the TFT array substrate 10, a liquid crystal layer 50 which is interposed between the TFT array substrate 10 and the opposite substrate 20, a sealing material 51 which surrounds the periphery of the liquid crystal layer 50, is partially provided with a liquid crystal injection hole 51a, and has a rectangular frame shape, and a sealant 52 which seals the liquid crystal injection hole 51a.

The TFT array substrate 10 is a substrate having an area greater than the opposite substrate 20. The TFT array substrate 10 has a projecting portion 10a which projects further outward than one end of the opposite substrate 20. The projecting portion 10a is provided with a terminal portion where a plurality of external circuit connection terminals 122 are formed. The opposite substrate 20 having nearly the same outline as the sealing material 51 is disposed so as to be opposite to the TFT array substrate 10 thereon, and the TFT array substrate 10 and the opposite substrate 20 are adhered to each other by the sealing material 51.

The sealing material 51 is provided along the circumferential edge of an opposite region between the TFT array substrate 10 and the opposite substrate 20. The liquid crystal injection hole 51a is provided at the side adjacent to the projecting portion 10a of four sides of the sealing material 51. The sealant 52 is coated at a position around the liquid crystal injection hole 51a of the projecting portion 10a along the end surface of the opposite substrate 20. A part of the sealant 52 permeates into a gap between the TFT array substrate 10 and the opposite substrate 20 from the liquid crystal injection hole 51a by the capillary phenomenon. The sealant 52 forms a sealing member 53 which seals the liquid crystal layer 50 between the TFT array substrate 10 and the opposite substrate 20 by surrounding the periphery of the liquid crystal layer 50 along with the sealing material 51.

A rectangular pixel region 1C in which a plurality of pixels PX1 and pixels PX2 are arranged in a matrix is provided in the central part of the region surrounded by the sealing member 53. An outer region of the pixel region 1C in the region surrounded by the sealing member 53 is a non-pixel region 1B in which pixels are not formed. A data line driving circuit or a scanning line driving circuit is provided in the outer region of the sealing member 53, and is not shown in FIGS. 1A and 1B.

The pixel region 1C is partitioned into a rectangular effective pixel region 1A including a plurality of pixels PX1 which contributes to image display and a dummy pixel region 1D having a rectangular frame shape and including a plurality of pixels PX2 which do not contribute to image display. The dummy pixel region 1D is formed in order to planarize the substrate surface in the effective pixel region 1A, to reduce a difference in electric characteristics of driving elements, or the like, and is formed by disposing one to ten pixels PX2 (dummy pixels) having the same configuration as the pixels PX1 of the effective pixel region 1A on the periphery of the effective pixel region 1A.

A trap portion 60 which traps impurities in the liquid crystal layer 50 by generating an electric field inside the liquid crystal layer 50 is provided between the pixel region 1C and the sealing member 53. The trap portion 60 includes a first electrode 61 formed on a substrate main body 10A of the TFT array substrate 10, a second electrode 62 which is formed to overlap the first electrode 61 such that a part of the first electrode 61 is exposed when the first electrode 61 is viewed from the liquid crystal layer 50 in a plane state, and an insulating layer 12 formed between the first electrode 61 and the second electrode 62. The width of the second electrode 62 is smaller than the width of the first electrode 61. In plan view where the liquid crystal device 1 is viewed from the opposite substrate 20 side, the edge of the first electrode 61 is further outward than the edge of the second electrode 62. The trap portion 60 traps impurities in the liquid crystal layer 50 using an electric field in the direction perpendicular to the liquid crystal layer thickness direction, generated between the first electrode 61 and the second electrode 62.

In addition, in the present specification, simply referring to the “width of the first electrode” and the “width of the second electrode” indicates widths of the “first electrode” and the “second electrode” in the direction (direction perpendicular to each side of the pixel region 1C) perpendicular to the direction along the outer circumference of the pixel region 1C.

The trap portion 60 is disposed so as to surround the pixel region 1C. In FIGS. 1A and 1B, in order to reliably trap impurities permeating into the pixel region 1C, the trap portion 60 is formed in a closed frame shape along the outer circumference of the pixel region 1C. The first electrode 61 is formed in a rectangular frame shape along the outer circumference of the pixel region 1C, and a part thereof is led to the left end of the terminal portion as a lead-out line 63. The second electrode 62 is formed in a rectangular frame shape along the outer circumference of the pixel region 1C, and a part thereof is led to the right end of the terminal portion as a lead-out line 64.

The substrate main body 10A is provided with driving elements (not shown) for driving the pixel electrodes 13 on a transparent base material such as glass or quartz, or an opaque base material such as silicon. The first electrode 61, a wire 11 connected to the driving elements, the insulating layer 12 covering the first electrode 61 and the wire 11, are formed on the substrate main body 10A, the second electrode 62 and the pixel electrodes 13 are formed on the insulating layer 12, and an alignment layer 14 is formed so as to cover the second electrode 62 and the pixel electrodes 13. The insulating layer 12 is commonly used as an insulating layer for insulating the first electrode 61 from the second electrode 62 and an insulating layer for insulating the pixel electrodes 13 from the wire 11.

The opposite substrate 20 includes a substrate main body 20A in which a black matrix (a light blocking film partitioning the pixels PX1 from the pixels PX2) or a peripheral partition (a light blocking film bordering the periphery of the pixel region 1C) is formed, and, a common electrode 21 which covers the entire surface of the pixel region 1C, and an alignment layer 22 which covers the common electrode 21, are formed on the substrate main body 20A.

The liquid crystal layer 50 is a vertical electric field type liquid crystal layer which is driven by an electric field (vertical electric field) in the liquid crystal layer thickness direction, generated between the pixel electrodes 13 and the common electrode 21. As the vertical electric field type, a VA (Vertical Alignment) type is representative, and other types such as an OCB (Optically Compensated Birefringence) type or a TN (Twisted Nematic) type may be used.

In FIGS. 1A and 1B, although the liquid crystal layer 50 is driven in the vertical electric field type by providing the common electrode 21 on the opposite substrate 20 side, the liquid crystal layer 50 may be driven by an electric field (horizontal electric field) which is nearly perpendicular to the liquid crystal layer thickness, generated by the pixel electrodes 13 and the common electrode by providing the common electrode 21 on the TFT array substrate 10 side. This driving type is called a horizontal electric field type. As the horizontal electric field type, an IPS (In-Plane Switching) type or an FFS (Fringe Field Switching) type is representative, but the FFS type easily causes image sticking, and thus a driving type such as the IPS type other than the FFS type is preferable.

In the liquid crystal device 1 having the above-described configuration, before image display, during image display, or after image display, an electric field, which is generated between the first electrode 61 and the second electrode 62 by applying a voltage between the first electrode 61 and the second electrode 62, acts on the liquid crystal layer 50, thereby trapping impurities in the liquid crystal layer 50. Thereby, for example, it is possible to suppress impurities which are eluted from the sealing member 53 from permeating into the pixel region 1C, and to thereby implement a liquid crystal device having few display defects such as image sticking.

Here, if impurities in the liquid crystal layer 50 are to be efficiently trapped, it is possible to shorten the distance between the first electrode 61 and the second electrode 62 so as to generate a large electric field between the first electrode 61 and the second electrode 62. In the liquid crystal device 1 according to the embodiment, the distance between the first electrode 61 and the second electrode 62 is controlled using the thickness of the insulating layer 12 insulating both the two from each other. In a typical semiconductor process, since the thickness of the insulating layer 12 can be easily thinned up to 100 nm, the distance between the first electrode 61 and the second electrode 62 can be shortened as compared with a case where the first electrode 61 and the second electrode 62 are spaced apart from each other with the liquid crystal layer 50 interposed therebetween or a case where the first electrode 61 and the second electrode 62 are formed to be arranged in the transverse direction.

For example, in a case where the first electrode 61 and the second electrode 62 are formed to be arranged in the transverse direction (in a case where the first electrode and the second electrode are patterned from the same conductive layer by a typical photo process using the i rays), the distance between the first electrode and the second electrode is only about 500 nm, but, in the liquid crystal device 1 according to the embodiment, the thickness of the insulating layer 12 is controlled to 400 nm using the typical semiconductor process. For this reason, according to the liquid crystal device 1 of the embodiment, it is possible to generate a large electric field between the first electrode 61 and the second electrode 62, and to thereby efficiently trap impurities in the liquid crystal layer 50.

### Second Embodiment

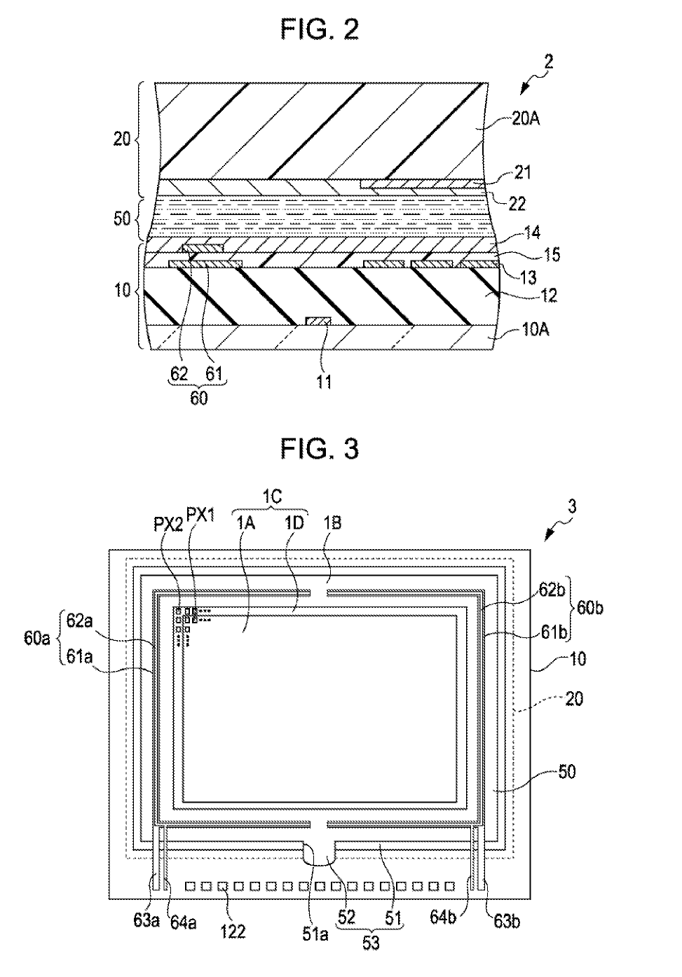

FIG. 2 is a cross-sectional view of the vicinity of a trap portion provided in a liquid crystal device 2 according to the second embodiment. In FIG. 2, constituent elements common to the liquid crystal device 1 according to the first embodiment are given the same reference numerals, and a detailed description thereof will be omitted.

The liquid crystal device 2 is different from the liquid crystal device 1 according to the first embodiment in that the first electrode 61 of the trap portion 60 is formed on the insulating layer 12 along with the pixel electrodes 13, a passivation layer 15 is formed so as to cover the first electrode 61 and the pixel electrodes 13, the second electrode 62 is formed on the passivation layer 15, and the alignment layer 14 is formed so as to cover the second electrode 62.

The passivation layer 15 is a protective film which protects the pixel electrodes 13. The passivation layer 15 is formed as a thin film of about 300 nm such that a large parasitic capacitance is not generated between the pixel electrodes 13 and the liquid crystal layer 50. For this reason, if such a thin film is used as an insulating layer between the first electrode 61 and the second electrode 62, the distance between the first electrode 61 and the second electrode 62 is shortened, and thus performance of trapping impurities is heightened.

In addition, if the second electrode 62 is formed on the passivation layer 15, since the trap portion 60 is disposed at a position close to the liquid crystal layer 50 with the alignment layer 14 interposed therebetween, an electric field generated by the trap portion 60 easily acts on the liquid crystal layer 50, and thus it is possible to efficiently trap impurities. Further, since the passivation layer 15 is commonly used as an insulating layer for insulating the first electrode 61 from the second electrode 62, there is an advantage in that the configuration is simplified as compared with a case where the passivation layer and the insulating layer are formed separately.

### Third Embodiment

FIG. 3 is a plan view of a liquid crystal device 3 according to the third embodiment. In FIG. 3, constituent elements common to the liquid crystal device 1 according to the first embodiment are given the same reference numerals, and a detailed description thereof will be omitted.

The liquid crystal device 3 is different from the liquid crystal device 1 according to the first embodiment in that trap portions 60a and 60b are formed so as to be divided in a plurality along the outer circumference of the pixel region 1C. The trap portion 60a is formed in a reverse U shape so as to surround the left half of the pixel region 1C, and the trap portion 60b is formed in a U shape so as to surround the right half of the pixel region 1C. The trap portion 60a and the trap portion 60b have a line-symmetric configuration with respect to a line passing through the center of the pixel region 1C.

A first electrode 61a of the trap portion 60a is formed in a reverse U shape along the outer circumference of the pixel region 1C, and a part thereof is led to the left end of the terminal portion as a lead-out line 63a. The second electrode 62a of the trap portion 60a is formed in a reverse U shape along the outer circumference of the pixel region 1C, and a part thereof is led to the left end of the terminal portion as a lead-out line 64a.

A first electrode 61b of the trap portion 60b is formed in a U shape along the outer circumference of the pixel region 1C, and a part thereof is led to the right end of the terminal portion as a lead-out line 63b. The second electrode 62b of the trap portion 60b is formed in a U shape along the outer circumference of the pixel region 1C, and a part thereof is led to the right end of the terminal portion as a lead-out line 64b.

In the liquid crystal device 3 according to the embodiment, there is concern that impurities may permeate into the pixel region 1C from the gaps between the divided trap portions 60a and 60b, but, if the gaps are made to be narrow, it is possible to show high trapping performance (performance of trapping impurities) in the same manner as a case of not being divided. In a case where the trap portion 60 is formed in a closed frame shape as in the liquid crystal device 1 according to the first embodiment, there is concern that since the lengths of the first electrode 61 and the second electrode 62 increase, voltage drop is generated on the way and thus a deviation occurs in impurity trapping performance, but in a case where the trap portions 60a and 60b are divided into a plurality, it is difficult for the problem to occur. Therefore, it is possible to show nearly uniform trapping performance at the overall trap portions 60a and 60b.

In addition, although the trap portions are divided as two parts along the outer circumference of the pixel region 1C in FIG. 3, the trap portions may be divided as three or more parts. In this case as well, it is possible to achieve the above-described effects.

### Fourth Embodiment

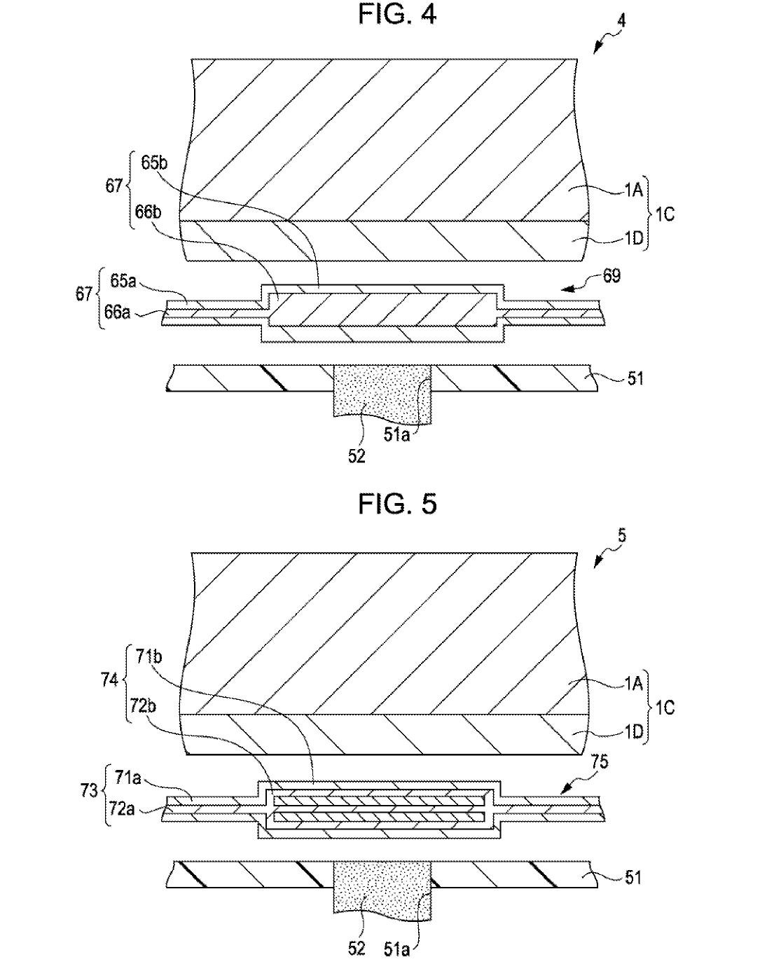

FIG. 4 is an enlarged plan view illustrating a configuration of a trap portion 69 around the sealant 52 provided in a liquid crystal device 4 according to the fourth embodiment. In FIG. 4, constituent elements common to the liquid crystal device 1 according to the first embodiment are given the same reference numerals, and a detailed description thereof will be omitted.

The liquid crystal device 4 is different from the liquid crystal device 1 according to the first embodiment in that the trap portion 69 is formed by a plurality of trap portions (a first trap portion 67 and a second trap portion 68) which have different impurity trapping performance, and the second trap portion 68 having high impurity trapping performance is disposed at a position opposite to the sealant 52 from which impurities are more easily eluted than from the sealing material 51. Impurities more easily accumulate at the sealing material 51 (second sealing region) around the liquid crystal injection hole 51a than at the sealing material 51 (first sealing region) spaced apart from the liquid crystal injection hole 51a. For this reason, the second trap portion 68 having high trapping performance is provided in the region where impurities easily accumulate.

In order to give higher impurity trapping performance to the second trap portion 68 than the first trap portion 67, the following method is taken. In other words, when the widths of the first electrode 65a and the first electrode 65b are used as the widths of the first trap portion 67 and the second trap portion 68, the width of the second trap portion 68 is larger than the width of the first trap portion 67. In this method, since the width of the second trap portion 68 is larger, impurities are trapped in the second trap portion 68 in a wide range, and thus the impurity trapping performance is heightened.

In addition, in FIG. 4, the width of the first electrode 65b of the second trap portion 68 is formed so as to be larger than the width of the first electrode 65a of the first trap portion 67, and thus the width of the second electrode 66b of the second trap portion 68 is formed so as to be larger than the width of the second electrode 66a of the first trap portion 67.

According to the liquid crystal device 4, since the trapping performance of the trap portion 69 is different for each region according to of the ease with which impurities are eluted, it is possible to better prevent impurities from permeating into the pixel region 1C.

### Fifth Embodiment

FIG. 5 is an enlarged plan view illustrating a configuration of a trap portion 75 around the sealant 52 provided in a liquid crystal device 5 according to the fifth embodiment. In FIG. 5, constituent elements common to the liquid crystal device 1 according to the first embodiment are given the same reference numerals, and a detailed description thereof will be omitted.

The liquid crystal device 5 is different from the liquid crystal device 1 according to the first embodiment in that the trap portion 75 is formed by a plurality of trap portions (a first trap portion 73 and a second trap portion 74) which have different impurity trapping performance, and the second trap portion 74 having high impurity trapping performance is disposed at a position opposite to the sealant 52 from which impurities are more easily eluted than from the sealing material 51. Impurities more easily accumulate at the sealing material 51 (second sealing region) around the liquid crystal injection hole 51a than at the sealing material 51 (first sealing region) spaced apart from the liquid crystal injection hole 51a. For this reason, the second trap portion 74 having high trapping performance is provided in the region where impurities easily accumulate.

In order to give higher impurity trapping performance to the second trap portion 74 than the first trap portion 73, the following method is taken. In other words, when each of the lengths of edges of a second electrode 72a and a second electrode 72b opposite to a first electrode 71a and a first electrode 71b is used as an interface distance, and an interface distance per unit length in the direction along the outer circumference of the pixel region 1C is used as a unit interface distance, a unit interface distance in the second trap portion 74 is larger than a unit interface distance in the first trap portion 73. In this method, since the unit interface distance in the second trap portion 74 is larger, an electric field density of the second trap portion 74 becomes great, and thus the impurity trapping performance is heightened.

As methods for increasing the unit interface distance, for example, as shown in FIG. 5, there is a method where a plurality of thin and long second electrodes 72b are disposed so as to be opposite to a single first electrode 71b. In the example shown in FIG. 5, the interface distance in the second trap portion 74 is calculated as a sum value of the interface distances of a plurality of second electrodes 72b, and the unit interface distance is obtained by dividing the sum value by the length of the first electrode 71b in the direction along the outer circumference of the pixel region 1C. Since the number of the second electrode 72a is one, the interface distance in the first trap portion 73 is the interface distance of the single second electrode 72a. Therefore, the unit interface distance is obtained by dividing the interface distance of the single second electrode 72a by the length of the first electrode 71a in the direction along the outer circumference of the pixel region 1C.

According to the liquid crystal device 5 of the embodiment, since the trapping performance of the trap portion 75 is different for each region according to the ease with which impurities are eluted, it is possible to better prevent impurities from permeating into the pixel region 1C.

### Modified Example of Fifth Embodiment

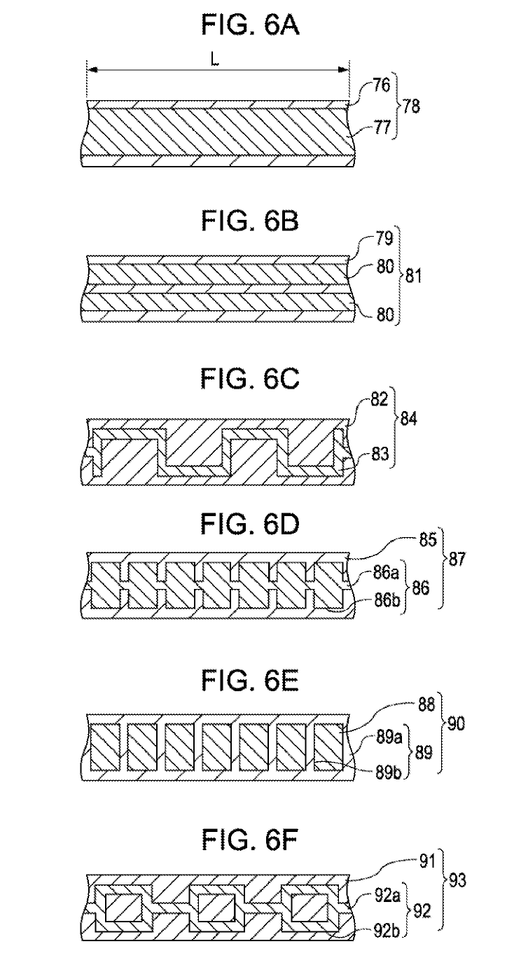

FIGS. 6A to 6F are plan views illustrating variations of the trap portion. In FIGS. 6A to 6F, the lengths of the first electrodes are all L.

FIG. 6A is a plan view of the trap portion 78 where the single second electrode 77 having a specific width is disposed so as to be opposite to the single first electrode 76. The lengths of the first electrode 76 and the second electrode 77 are all L. Therefore, the interface distance is 2L, and the unit interface distance is 2.

FIG. 6A shows the same configuration as the configuration of the first trap portion 73 shown in FIG. 5. The unit interface density is larger in the second trap portion than in the first trap portion, and, configuration examples thereof are shown in FIGS. 6B to 6F.

FIG. 6B is a plan view of the trap portion 81 where a plurality of second electrodes 80 having a specific width are disposed so as to be opposite to the first electrode 79. The lengths of the first electrode 79 and the second electrode 80 are all L. Therefore, the interface distance is 4L, and the unit interface distance is 4.

FIG. 6C is a plan view of the trap portion 84 where the single second electrode 83 which has a specific width and is formed in a meandering manner is disposed so as to be opposite to the single first electrode 82. The length of the first electrode 82 is L, and the length of the second electrode 83 in the meandering direction is larger than L. Therefore, the interface distance is larger than 2L, and the unit interface distance is larger than 2.

FIG. 6D is a plan view of the trap portion 87 where the second electrode 86 is formed so as to have a stripe-shaped main line portion 86a and a plurality of branch portions 86b which are branched out from the main line portion 86a. The length of the first electrode 85 is L, and the interface distance of the second electrode 86 is larger than 2L. Therefore, the unit interface distance is larger than 2.

FIG. 6E is a plan view of the trap portion 90 where the second electrode 89 is formed in a trapezoidal shape so as to have the frame portion 89a with a rectangular frame shape and a plurality of step portions 89b connected to the frame portion 89a. The length of the first electrode 88 is L, and the interface distance of the second electrode 89 is larger than 2L. Therefore, the unit interface distance is larger than 2.

FIG. 6F is a plan view of the trap portion 93 where the second electrode 92 is formed so as to have a plurality of rectangular ring portions 92b and the connection portions 92a connecting the plurality of ring portions 92b to each other. The length of the first electrode 91 is L, and the interface distance of the second electrode 92 is larger than 2L. Therefore, the unit interface distance is larger than 2.

The configurations shown in FIGS. 6B to 6F are only an example. In addition thereto, configurations for increasing the unit interface distance may be diversified, but all of them may not be shown, and thus only representative examples are shown. It is possible to relatively freely change the size of the unit interface distance by variously changing a shape of the second electrode.

### Sixth Embodiment

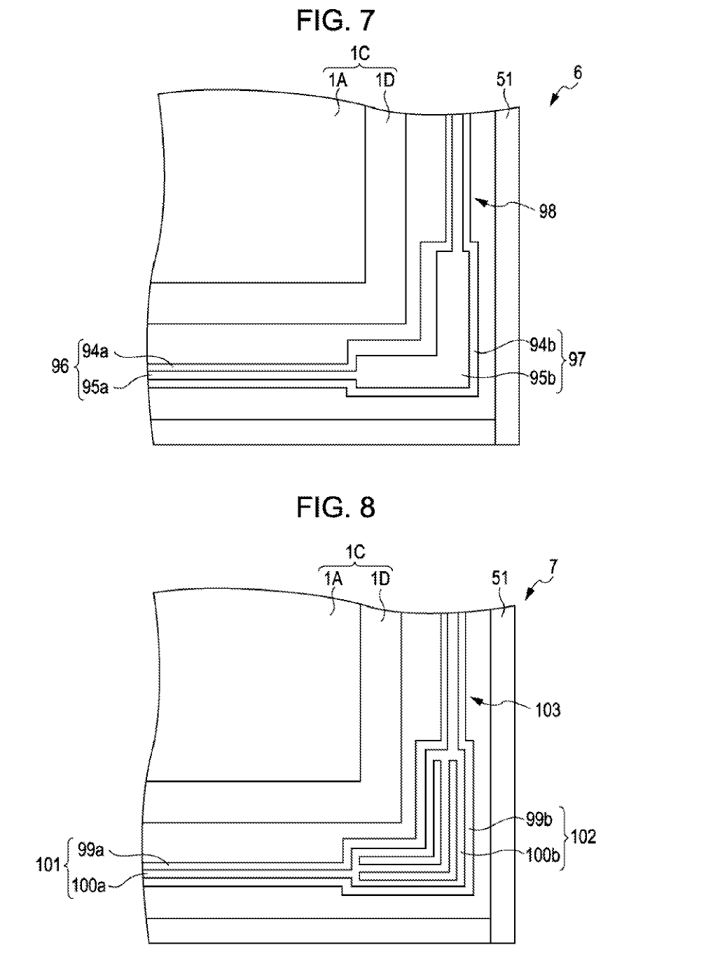

FIG. 7 is an enlarged plan view illustrating a configuration of a trap portion 98 around the corner of the sealing material 51 provided in a liquid crystal device 6 according to a sixth embodiment. In FIG. 7, constituent elements common to the liquid crystal device 1 according to the first embodiment are given the same reference numerals, and a detailed description thereof will be omitted.

The liquid crystal device 6 is different from the liquid crystal device 1 according to the first embodiment in that the trap portion 98 is formed by a plurality of trap portions (a first trap portion 96 and a second trap portion 97) which have different impurity trapping performance, and the second trap portion 97 having high impurity trapping performance is disposed at a position opposite to the corner (second sealing region) of the sealing material 51 from which impurities are more easily eluted than from the straight line (the part other than the corner: first sealing region) of the sealing material 51.

In order to give higher impurity trapping performance to the second trap portion 97 than the first trap portion 96, the following method is taken. In other words, when the widths of the first electrode 94a and the first electrode 94b are used as the widths of the first trap portion 96 and the second trap portion 97, the width of the second trap portion 97 is larger than the width of the first trap portion 96. In this method, since the width of the second trap portion 97 is larger, impurities are trapped in the second trap portion 97 in a wide range, and thus the impurity trapping performance is heightened.

In addition, in FIG. 7, the width of the first electrode 94b of the second trap portion 97 is formed so as to be larger than the width of the first electrode 94a of the first trap portion 96, and thus the width of the second electrode 95b of the second trap portion 97 is formed so as to be larger than the width of the second electrode 95a of the first trap portion 96.

According to the liquid crystal device 6, since the trapping performance of the trap portion 98 is different for each region according to of the ease with which impurities are eluted, it is possible to better prevent impurities from permeating into the pixel region 1C.

### Seventh Embodiment

FIG. 8 is an enlarged plan view illustrating a configuration of a trap portion 103 around the corner of the sealing material 51 provided in a liquid crystal device 7 according to a seventh embodiment. In FIG. 8, constituent elements common to the liquid crystal device 1 according to the first embodiment are given the same reference numerals, and a detailed description thereof will be omitted.

The liquid crystal device 7 is different from the liquid crystal device 1 according to the first embodiment in that the trap portion 103 is formed by a plurality of trap portions (a first trap portion 101 and a second trap portion 102) which have different impurity trapping performance, and the second trap portion 102 having high impurity trapping performance is disposed at a position opposite to the corner (second sealing region) of the sealing material 51 from which impurities are more easily eluted than from the straight line (the part other than the corner: first sealing region) of the sealing material 51.

In order to give higher impurity trapping performance to the second trap portion 102 than the first trap portion 101, the following method is taken. In other words, when each of the lengths of edges of a second electrode 100a and a second electrode 100b opposite to a first electrode 99a and a first electrode 99b is used as an interface distance, and an interface distance per unit length in the direction along the outer circumference of the pixel region 1C is used as a unit interface distance, a unit interface distance in the second trap portion 102 is larger than a unit interface distance in the first trap portion 101. In this method, since the unit interface distance in the second trap portion 102 is larger, an electric field density of the second trap portion 102 becomes great, and thus the impurity trapping performance is heightened.

As methods for increasing the unit interface distance, for example, as shown in FIG. 8, there is a method where a plurality of thin and long second electrodes 100b are disposed so as to be opposite to a single first electrode 99b. In the example shown in FIG. 8, the interface distance in the second trap portion 102 is calculated as a sum value of the interface distances of a plurality of second electrodes 100b, and the unit interface distance is obtained by dividing the sum value by the length of the first electrode 99b in the direction along the outer circumference of the pixel region 1C. Since the number of the second electrode 100a is one, the interface distance in the first trap portion 101 is the interface distance of the single second electrode 100a. Therefore, the unit interface distance is obtained by dividing the interface distance of the single second electrode 100a by the length of the first electrode 99a in the direction along the outer circumference of the pixel region 1C.

According to the liquid crystal device 7 of the embodiment, since the trapping performance of the trap portion 103 is different for each region according to of the ease with which impurities are eluted, it is possible to better prevent impurities from permeating into the pixel region 1C.

In the liquid crystal device 7 according to the embodiment, a plurality of second electrodes 100b have been disposed so as to be opposite to the single first electrode 99b in order to increase the unit interface distance of the second trap portion 102. However, a method of increasing the unit interface distance is not limited thereto, and the methods shown in FIGS. 6C to 6F may be used.

### Eighth Embodiment

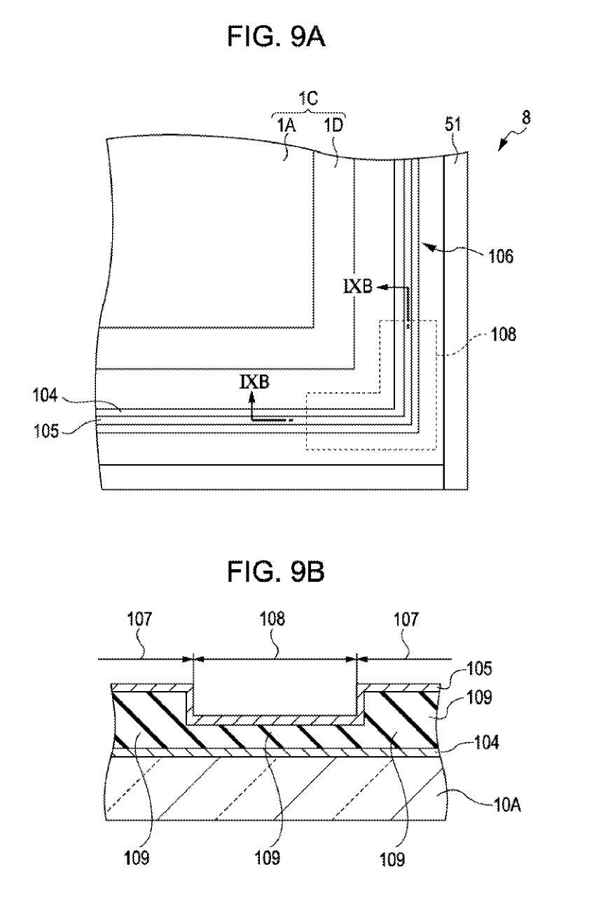

FIG. 9A is an enlarged plan view illustrating a configuration of a trap portion 106 around the corner of the sealing material 51 provided in a liquid crystal device 8 according to an eighth embodiment, and FIG. 9B is a cross-sectional view taken along the line IXB-IXB of FIG. 9A. In FIGS. 9A and 9B, constituent elements common to the liquid crystal device 1 according to the first embodiment are given the same reference numerals, and a detailed description thereof will be omitted.

The liquid crystal device 8 is different from the liquid crystal device 1 according to the first embodiment in that the trap portion 106 is formed by a plurality of trap portions (a first trap portion 107 and a second trap portion 108) which have different impurity trapping performance, and the second trap portion 108 having high impurity trapping performance is disposed at a position opposite to the corner (second sealing region) of the sealing material 51 from which impurities are more easily eluted than from the straight line (the part other than the corner: first sealing region) of the sealing material 51.

In order to give higher impurity trapping performance to the second trap portion 108 than the first trap portion 107, the thickness of the insulating layer 109b of the second trap portion 108 is smaller than the thickness of the insulating layer 109a of the first trap portion 107. As methods for differentiating the thickness of the insulating layer 109 for each region, a well-known method such as etching or half exposure may be used. In this method, since the distance between the first electrode 104 and the second electrode 105 in the second trap portion 108 is reduced, a large electric field is generated in the second trap portion 108, and thus the impurity trapping performance is heightened.

According to the liquid crystal device 8, since the trapping performance of the trap portion 106 is different for each region according to the ease with which impurities are eluted, it is possible to better prevent impurities from permeating into the pixel region 1C.

### Ninth Embodiment

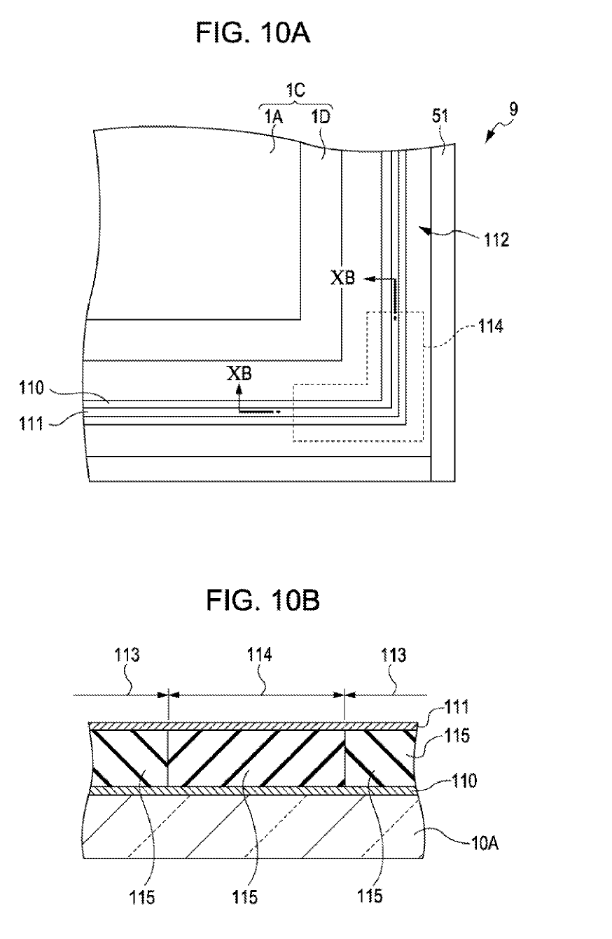

FIG. 10A is an enlarged plan view illustrating a configuration of a trap portion 112 around the corner of the sealing material 51 provided in a liquid crystal device 9 according to a ninth embodiment, and FIG. 10B is a cross-sectional view taken along the line XB-XB of FIG. 10A. In FIGS. 10A and 10B, constituent elements common to the liquid crystal device 1 according to the first embodiment are given the same reference numerals, and a detailed description thereof will be omitted.

The liquid crystal device 9 is different from the liquid crystal device 1 according to the first embodiment in that the trap portion 112 is formed by a plurality of trap portions (a first trap portion 113 and a second trap portion 114) which have different impurity trapping performance, and the second trap portion 114 having high impurity trapping performance is disposed at a position opposite to the corner (second sealing region) of the sealing material 51 from which impurities are more easily eluted than from the straight line (the part other than the corner: first sealing region) of the sealing material 51.

In order to give higher impurity trapping performance to the second trap portion 114 than the first trap portion 113, the dielectric constant of the insulating layer 115b of the second trap portion 114 is greater than the dielectric constant of the insulating layer 115a of the first trap portion 113. As methods for differentiating the dielectric constant of the insulating layer 115 for each region, for example, a material of the insulating layer 115 may be different for each region. In the example shown in FIGS. 10A and 10B, the insulating layer 115a of the first trap portion 113 is made of SiOx, and the insulating layer 115b of the second trap portion 114 is made of SiNx or TaOx. In this method, since the dielectric constant of the insulating layer 115b of the second trap portion 114 is larger, the electric field density of the second trap portion 114 increases, and thus the impurity trapping performance is heightened.

According to the liquid crystal device 9, since the trapping performance of the trap portion 112 is different for each region according to the ease with which impurities are eluted, it is possible to better prevent impurities from permeating into the pixel region 1C.

### Electronic Apparatus

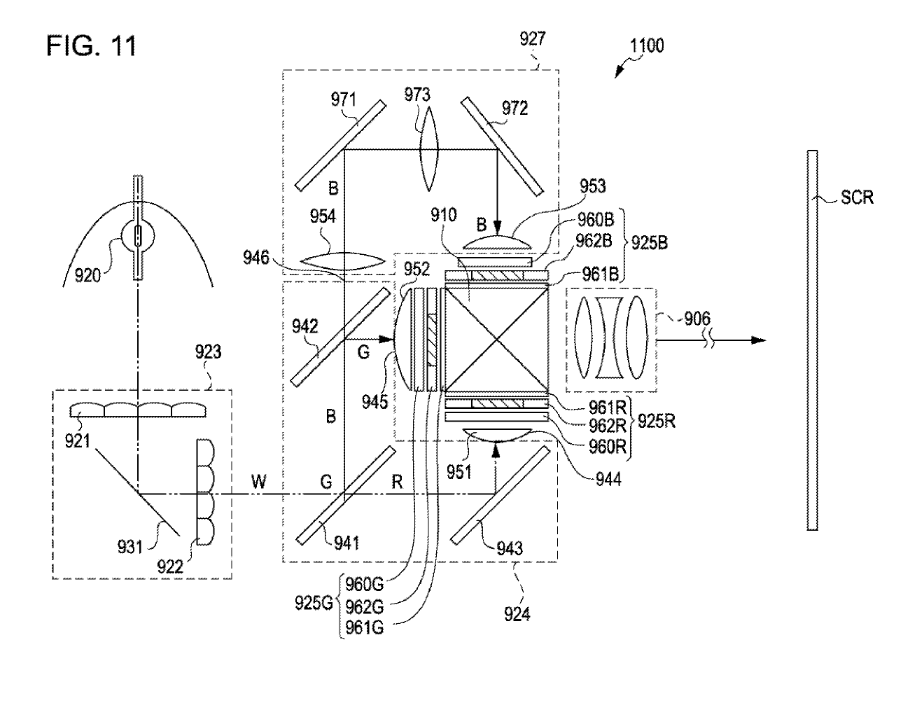

FIG. 11 is a diagram illustrating an example of the electronic device including the liquid crystal device according to the embodiments. The electronic apparatus in FIG. 11 is a projector 1100 in which the above-described three liquid crystal devices are prepared and are respectively used as liquid crystal devices 962R, 962G and 962B for RGB.

As optical systems of the projector 1100, a light source device 920 and a uniform illumination optical system 923 are employed. The projector 1100 includes a color separation optical system 924 which separates the light beams W emitted from the uniform illumination optical system 923 into light beams of red (R), green (G) and blue (B) as a color separation section, three light valves 925R, 925G and 925B as a modulation section for modulating the respective color light beams R, G and B, a color synthesis prism 910 which re-synthesizes color light beams after being modulated, and a projection lens unit 906 as a projection section which enlarges and projects the synthesized light beams onto a surface of the projection screen SCR. In addition, a light guide system 927 is provided which guides the blue light beam B to the corresponding light valve 925B.

The uniform illumination optical system 923 includes two lens plates 921 and 922, and a reflection mirror 931, and the two lens plates 921 and 922 are disposed in a perpendicular state with the reflection mirror 931 interposed therebetween. The two lens plate 921 and 922 of the uniform illumination optical system 923 respectively include a plurality of rectangular lenses which are arranged in a matrix. Light beams emitted from the light source device 920 are divided into a plurality of partial light beams by the rectangular lenses of the first lens plate 921. In addition, the partial light beams are superposed around the three light valves 925R, 925G and 925B by the rectangular lenses of the second lens plate 922. Therefore, by the use of the uniform illumination optical system 923, even if the light source device 920 has nonuniform illuminance distribution in the cross section of the emitted light beam, the three light valves 925R, 925G and 925B can be illuminated with uniform illumination light.

The color separation optical system 924 includes blue and green reflection dichroic mirror 941, a green reflection dichroic mirror 942, and a reflection mirror 943. First, the blue light beam B and the green light beam G included in the light beams W are reflected perpendicularly in the blue and green reflection dichroic mirror 941 and travel toward the green reflection dichroic mirror 942. The red light beam R passes through the mirror 941 and is perpendicularly reflected by the rear reflection mirror 943, and is output to the color synthesis prism 910 side from an exit portion 944 of the red light beam R. Next, in the green reflection dichroic mirror 942, only the green light beam G of the blue and green light beams B and G reflected by the blue and green reflection dichroic mirror 941 is reflected perpendicularly and is output to the color synthesis optical system from an exit portion 945 of the green light beam G. The blue light beam B having passed through the green reflection dichroic mirror 942 is output to the light guide system 927 side from an exit portion 946 of the blue light beam B. In this example, distances from the exit portion of the light beams W of the uniform illumination optical system to the exit portions 944, 945 and 946 of the respective light beams in the color separation optical system 924 are set to be substantially the same as each other.

Condenser lenses 951 and 952 are disposed on the exit sides of the exit portions 944 and 945 of the red and green light beams R and G of the color separation optical system 924. Therefore, the red and green light beams R and G output from the respective exit portions are incident to the condenser lenses 951 and 952 and become parallel. The red and green light beams R and G which become parallel in this way are incident to the light valves 925R and 925G so as to be modulated, and image information corresponding to each color light beam is added thereto. That is to say, the liquid crystal devices are controlled to be switched by a driving section (not shown) in response to the image information, and thereby each color light beam pass therethrough is modulated. On the other hand, the blue light beam B is guided to the corresponding light valve 925B via the light guide system 927, and is modulated in response to image information in the same manner here. In addition, the light valves 925R, 925G and 925B are liquid crystal light valves respectively including incidence side polarization sections 960R, 960G and 960B, exit side polarization sections 961R, 961G and 961B, and liquid crystal devices 962R, 962G and 962B.

The light guide system 927 includes a condenser lens 954 disposed on the exit side of the exit portion 946 of the blue light beam B, an incidence side reflection mirror 971, an exit side reflection mirror 972, an intermediate lens 973 disposed therebetween, and a condenser lens 953 disposed in front of the light valve 925B. The blue light beam B output from the condenser lens 954 is guided to the liquid crystal device 962B via the light guide system 927 and then is modulated. Of the light path lengths of the respective color light beams, that is, distances from the exit portion of the light beams W to the respective liquid crystal devices 962R, 962G and 962B, the blue light beam B has the longest distance, and thus a light amount loss of the blue light beam is the largest. However, it is possible to suppress the light amount loss via the light guide system 927. The respective light beams R, G and B which have been modulated via the respective light valves 925R, 925G and 925B are incident to the color synthesis prism 910 and are synthesized here. In addition, light synthesized by the color synthesis prism 910 is enlarged and projected onto the surface of the projection screen SCR which is located at a predetermined position, via the projection lens unit 906.

In the projector 1100, the liquid crystal devices 962R, 962G and 962B have the configurations according to the above-described embodiments. For this reason, it is possible to efficiently trap impurities in the liquid crystal layer and to thereby implement the projector 1100 where image sticking is difficult to generate and which thus has excellent display quality.

In addition, a description of the transmissive liquid crystal device where the pixel electrode and the common electrode are formed a transparent conductive film such as ITO has been made in the embodiments. However, the invention may be applied to a reflective liquid crystal device where the pixel electrode is made of a reflective material, and, in this case, the projector 1100 is also a reflective projector.

The entire disclosure of Japanese Patent Application No. 2011-068216, filed Mar. 25, 2011 is expressly incorporate by reference herein.

What is claimed is:

1. A liquid crystal device comprising:
a first substrate;
a second substrate disposed so as to be opposite to the first substrate;
a liquid crystal layer interposed between the first substrate and the second substrate;
a sealing material surrounding the liquid crystal layer and adhering the first substrate to the second substrate;
a pixel region provided in a region surrounded by the sealing material and including a plurality of pixels; and
a trap portion disposed between the pixel region and the sealing material,
wherein the trap portion includes a first electrode formed on the first substrate, a second electrode disposed to overlap the first electrode such that a part of the first electrode is exposed when the first electrode is viewed from the liquid crystal layer in a plane state, and an insulating layer formed between the first electrode and the second electrode, and traps impurities in the liquid crystal layer by an electric field generated between the first electrode and the second electrode.

2. The liquid crystal device according to claim 1, wherein a driving type of the pixels is a driving type other than an FFS (Fringe Field Switching) type.

3. The liquid crystal device according to claim 1, wherein the trap portion is disposed so as to surround the pixel region.

4. The liquid crystal device according to claim 3, wherein the trap portion is formed in a closed frame shape along an outer circumference of the pixel region.

5. The liquid crystal device according to claim 3, wherein the trap portion is formed so as to be divided into a plurality along an outer circumference of the pixel region.

6. The liquid crystal device according to claim 3,
wherein the sealing material includes a first sealing region, and a second sealing region where, unlike the first sealing region, impurities are more easily eluted or more easily accumulate, and
wherein the trap portion includes
a first trap portion provided at a position opposite to the first sealing region; and
a second trap portion provided at a position opposite to the second sealing region and having higher impurity trapping performance than the first trap portion.

7. The liquid crystal device according to claim 6, wherein if a width of the first electrode in a direction perpendicular to the direction along the outer circumference of the pixel region is a width of the trap portion, a width of the second trap portion is larger than the width of the first trap portion.

8. The liquid crystal device according to claim 6, wherein if a length of the edge of the second electrode opposite to the first electrode is an interface distance, and an interface distance per unit length in the direction along the outer circumference of the pixel region is a unit interface distance, a unit interface distance in the second trap portion is larger than a unit interface distance in the first trap portion.

9. The liquid crystal device according to claim 8, wherein a plurality of second electrodes are disposed so as to be opposite to the single first electrode in the second trap portion.

10. The liquid crystal device according to claim 8, wherein the single second electrode is disposed so as to be opposite to the single first electrode in a meandering manner in the second trap portion.

11. The liquid crystal device according to claim 8, wherein the second electrode is formed in a trapezoidal shape so as to have a frame portion with a rectangular frame shape and a plurality of step portions connected to the frame portion in the second trap portion.

12. The liquid crystal device according to claim 8, wherein the second electrode is formed so as to have a stripe-shaped main line and a plurality of branches branched out from the main line in the second trap portion.

13. The liquid crystal device according to claim 8, wherein the second electrode is formed so as to have a plurality of ring portions and connection portions connecting the plurality of ring portions to each other in the second trap portion.

14. The liquid crystal device according to claim 6, wherein a thickness of the insulating layer of the second trap portion is smaller than a thickness of the insulating layer of the first trap portion.

15. The liquid crystal device according to claim 6, wherein a dielectric constant of the insulating layer of the second trap portion is greater than a dielectric constant of the insulating layer of the first trap portion.

16. The liquid crystal device according to claim 1,
wherein the first substrate is provided with a pixel electrode formed for each pixel and a wire connected to the pixel electrode, and
wherein the pixel electrode and the wire are insulated from each other by the insulating layer.

17. The liquid crystal device according to claim 1, wherein the first substrate is provided with a pixel electrode formed for each pixel, the insulating layer covering the pixel electrode, and an alignment layer covering the insulating layer.

18. An electronic apparatus comprising the liquid crystal device according to claim 1.

19. An electronic apparatus comprising the liquid crystal device according to claim 2.

20. An electronic apparatus comprising the liquid crystal device according to claim 3.
